(19) United States
(12) Patent Application Publication
(10) Pub. No.: US 2016/0107192 A1
(43) Pub. Date: Apr. 21, 2016

(54) Thick Growth Nanocoatings

(71) Applicant: The Texas A&M System Technology Commercialization, College Station, TX (US)

(72) Inventors: Jaime Grunlan, College Station, TX (US); Tyler Guin, Bryan, TX (US)

(73) Assignee: Texas A&M University System, College Station, TX (US)

(21) Appl. No.: 14/918,529

(22) Filed: Oct. 20, 2015

Related U.S. Application Data
(60) Provisional application No. 62/066,080, filed on Oct. 20, 2014.

(51) Int. Cl. B05D 7/00

(52) U.S. Cl. CPC B05D 7/52

(57) ABSTRACT

A layer-by-layer deposition process for a thin film having a polyelectrolyte and a complementary species includes calibrating a buffered polyelectrolyte solution and a buffered rinse solution, depositing a polyelectrolyte layer on a substrate, and depositing a complementary species layer on the polyelectrolyte layer. Depositing a polyelectrolyte layer includes applying the buffered polyelectrolyte solution to the substrate and applying the buffered rinse solution to the substrate after the buffered polyelectrolyte solution has been applied. Depositing a complementary species layer includes applying a complementary species mixture to the substrate and applying a complementary species rinse solution to the substrate after the complementary species mixture has been applied.

### CROSS-REFERENCE TO RELATED APPLICATIONS

This application is a non-provisional application that claims the benefit of U.S. Application Ser. No. 62/066,080 filed on Oct. 20, 2014, which is incorporated by reference herein in its entirety.

### TECHNICAL FIELD

The present disclosure relates to thin film fabrication. In particular, it relates to multilayer thin films produced by layer-by-layer deposition.

### BACKGROUND

Substrates, such as microelectronics and packaging, may be coated with one or more thin films to significantly reduce oxygen transmission to the substrate. Current coating techniques include physical vapor deposition, chemical vapor deposition, and electro-deposition. Many of these techniques require expensive equipment and complex operating conditions unsuitable for certain substrates.

Layer-by-layer deposition is a method of fabricating multilayer thin films that may be performed with a variety of materials and for a variety of substrate configurations. Layers of molecules are deposited sequentially onto a substrate through complementary molecular interactions, such as electrostatic attraction and donor/acceptor attraction, to form alternating layers of materials. Deposition of a bilayer involves applying a first material, such as a polyelectrolyte or charge donor, to the surface of a substrate, rinsing the coated substrate, and repeating the application and rinse process for a second material, such as a polyelectrolyte having the opposite charge or a charge acceptor. Each layer is very thin and many layers may be deposited to achieve a particular property for the thin film. Thin films created by layer-by-layer deposition may be used on substrates as an oxygen barrier, flame retardant, or electrical conductor.

### SUMMARY

In an embodiment of the disclosure, a layer-by-layer deposition process for a thin film having a polyelectrolyte and a complementary species, includes calibrating a buffered polyelectrolyte solution and a buffered rinse solution, depositing a polyelectrolyte layer on a substrate, and depositing a complementary species layer on the polyelectrolyte layer. Depositing a polyelectrolyte layer includes applying the buffered polyelectrolyte solution to the substrate and applying the buffered rinse solution to the substrate after the buffered polyelectrolyte solution has been applied. Depositing a complementary species layer includes applying a complementary species mixture to the substrate and applying a complementary species rinse solution to the substrate after the complementary species mixture has been applied.

In an embodiment of the disclosure, a layer-by-layer process for creating a thin film, includes providing a buffered polyelectrolyte solution, a buffered rinse solution, a complementary species mixture, and a complementary rinse solution, applying the buffered polyelectrolyte solution to a substrate to create a polyelectrolyte layer, applying the buffered rinse solution to the substrate after the buffered polyelectrolyte solution has been applied, applying the complementary species mixture to the substrate after the buffered rinse solution has been applied to create a complementary species layer, and applying the complementary rinse solution to the substrate after the complementary species mixture has been applied. The buffered polyelectrolyte solution includes a polyelectrolyte and a buffer, the buffered rinse solution includes the buffer, and the complementary species mixture includes a complementary species;

### BRIEF DESCRIPTION OF THE DRAWINGS

The drawings included in the present application are incorporated into, and form part of, the specification. They illustrate embodiments of the present invention and, along with the description, serve to explain the principles of the invention. The drawings are only illustrative of embodiments of the invention and do not limit the invention.

FIG. 1 is a diagram of a layer-by-layer deposition process to form one or more bilayers of a polyelectrolyte and a complementary species on a substrate, according to embodiments of the disclosure.

FIG. 2A is an exemplary diagram of a substrate coated in two bilayers of a nano-object and a polyelectrolyte, according to embodiments of the disclosure.

FIG. 2B is an exemplary flow diagram of a process for creating a coated substrate such as that of FIG. 2A, according to embodiments of the disclosure.

FIG. 3A is a graph of thin film thickness as a function of tris concentration for 8 bilayer CH-tris/VMT assemblies deposited on silicon wafers, according to embodiments of the disclosure.

FIG. 3B is a graph of thin film thickness as a function of bilayers deposited with 50 mM tris in a CH solution and rinse on silicon wafers, according to embodiments of the disclosure.

FIG. 3C is a graph of thin film mass deposited as a function of bilayers deposited with 50 mM tris in a CH solution and rinse, according to embodiments of the disclosure

FIG. 4A is an optical micrograph of a cross-section of an 8 bilayer CH-tris/VMT film, deposited on PET and embedded in epoxy, taken in phase contrast mode, according to embodiments of the disclosure.

FIG. 4B is a TEM micrograph of the outermost edge of the cross-section of an 8 bilayer CH-tris/VMT film, deposited on PET and embedded in epoxy, according to embodiments of the disclosure.

### DETAILED DESCRIPTION

A typical layer-by-layer deposition process involves alternating adsorption and rinse steps. For example, in a layer-by-layer deposition process for an anionic/cationic two-polymer thin film, a substrate is immersed into an anionic polymer solution. Anionic polymers adsorb to the surface of the substrate to form a thin coating with a negative surface charge. The substrate is rinsed with deionized water to remove excess, unadsorbed molecules. The coated substrate is then immersed into a cationic polymer solution. Cationic polymers adsorb to the anionic polymer layer to create a bilayer thin film with a positive surface charge. The bilayer coated substrate is rinsed and the adsorption and rinse process continues in alternation until a thin film with the desired properties is created from multiple layers.

Typical electrolytic layer-by-layer deposition processes are controlled through the properties of the adsorption solutions. The composition of the deposition species and the conditions of the adsorption solutions and suspensions applied to the substrate may be selected to achieve certain properties in the resultant thin film. In the example above, parameters such as pH, polymer concentration, and ionic strength of each electrolytic solution may be selected and controlled to achieve a desired thickness and growth rate of each polymer layer in the thin film. The neutral wash steps are used to remove excess molecules between adsorption applications and prepare the coated surface for a new layer application.

According to embodiments of the disclosure, a layer-by-layer deposition process may deposit a thin film with desired properties using fewer layers than conventional layer-by-layer deposition processes. The thin film may have one or more bilayers of a polyelectrolyte and a complementary species alternatively deposited onto a substrate. This inventive deposition process uses buffered polyelectrolyte and rinse solutions, where the incorporated buffers of the polyelectrolyte and rinse solutions may complement the polyelectrolyte and complementary species deposition. By using buffered polyelectrolyte and rinse solutions, a thin film with desired properties may require fewer applications than a layer-by-layer deposition process calibrated and controlled only through adsorption steps.

A polyelectrolyte may be adsorbed onto a substrate through a buffered polyelectrolyte solution and rinsed with a buffered rinse solution. This buffered rinse solution may be calibrated to the polyelectrolyte solution to encourage desired properties of the layers. For example, the buffered rinse solution may have a similar buffer/salt concentration and pH as the buffered polyelectrolyte solution. A second layer species may be adsorbed onto the polyelectrolyte layer through a second adsorption mixture and rinsed with a rinse mixture, which may be calibrated to the second adsorption mixture. This deposition process may be repeated for multiple layers to achieve a desired thickness or morphology.

This buffered adsorption and buffered rinse process may produce thicker thin films for a given number of layers than layer-by-layer deposition processes without buffered rinses. Fewer layers may be required to achieve certain desired properties of the thin films, such as thickness, film mass, and nano-object alignment. This reduction in number of layers may simplify processing and decrease the cost of applying nanocoatings to substrates. A wide variety of materials may be used to form the thin films for a variety of properties, including electrical, optical, gas barrier, anti-microbial, hydrophobicity, and flame retardation.

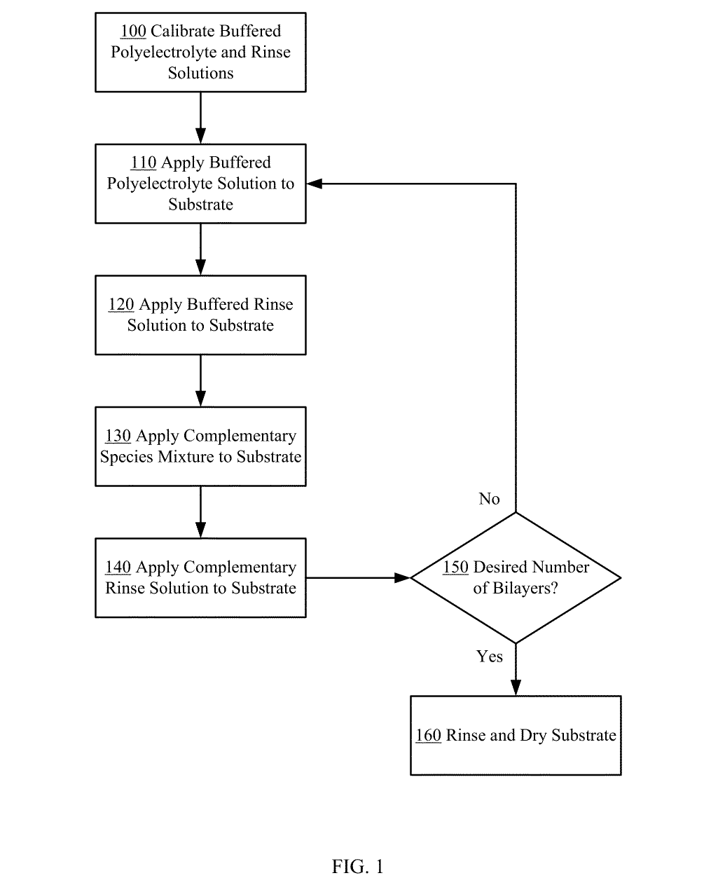

FIG. 1 is a diagram of a layer-by-layer deposition process to form one or more bilayers of a polyelectrolyte and a complementary species on a substrate, according to embodiments of the disclosure. While only two species are shown, multiple species may be used in a variety of combinations and application orders. For example, a quadlayer may be formed of a polyelectrolyte, a first complementary species, the polyelectrolyte, and a second complementary species.

The buffered polyelectrolyte and rinse solutions may be calibrated with a buffer or salt, as in 100. While other species' deposition and rinse solutions may also be calibrated, the polyelectrolyte solution and its rinse solution may be specifically calibrated with a buffer or salt to control or improve desired thin film properties or promote thin film growth. The buffered polyelectrolyte solution and buffered rinse solution may share similar conditions, such as pH, buffer/salt concentration, solute, and ionic strength. In other embodiments, the buffered polyelectrolyte solution and buffered rinse solution may have different conditions. In addition to the polyelectrolyte solution, one or more complementary species mixtures may be calibrated and controlled through both deposition and rinse steps. For example, for electrolytic thin films, the complementary species may have a net charge opposite to the net charge of the polyelectrolyte. The complementary species mixtures may incorporate buffers, salts, or acids/bases into their adsorption solutions/suspensions and rinse solutions to promote adsorption or film growth. The complementary species mixture and complementary rinse solution may share similar conditions, such as pH, solute, and ionic strength. Additionally, the substrate may be prepared to increase the surface charge and aid in adsorption, such as through surface treatment.

One or more polyelectrolytes may be selected for their thin film and electrolytic deposition properties. Polyelectrolyte selection parameters related to favorable layer-by-layer deposition and thin film formation may include, but are not limited to, charge density, functional group, charge group, swelling tendency, and alternating adsorption layer species. A variety of polyelectrolytes may be used including, but not limited to: cationic polyelectrolytes, such as poly(allylamine), polymelamine, poly(melamine-co-formaldehyde), polyvinylpyridine, poly(allylamine hydrochloride) (PAH), poly(2-ethyl-2-oxazoline), poly(diallyl dimethyl ammonium chloride) (polyDADMAC), and polyethylenimine (PEI); anionic polyelectrolytes, such as poly(acrylic acid) salts, poly(vinyl sulfate), poly(methacrylic acid), and poly(sodium styrene sulfonate); and natural polyelectrolytes, such as chitosan and collagen. In some embodiments, the polyelectrolyte concentration is between 0.05 M and 1 M.

A buffer or salt used in the buffered polyelectrolyte and rinse solutions may be selected according to parameters associated with the deposition of polyelectrolyte and complementary species layers. For example, a cationic polyelectrolyte may be supported by a salt at a high enough concentration to screen the charges of the polyelectrolyte and consequently increase polyelectrolyte layer thickness; a CH-tris/VMT thin film prepared with a CH-tris electrolyte solution may have a thickness five times greater than a CH/VMT thin film without tris buffer. As another example, an anionic clay may be supported by a buffer at a particular concentration to control the amount of clay deposited, thin film thickness, or ordering of the clay nano-objects; a CH-tris/VMT thin film prepared with both a CH-tris electrolyte solution and tris rinse solution may have a thickness two times greater than a CH-tris/VMT thin film without tris rinse solution and ten times greater than a CH/VMT thin film without tris buffer. Salt/buffer selection and calibration parameters may include, but are not limited to, polyelectrolyte composition, polyelectrolyte concentration, salt/buffer composition, salt/buffer concentration, ionic strength of solution, complementary species composition, and pH. A variety of salts or buffers may be incorporated into one or more polyelectrolyte and rinse solutions used in the deposition process to support deposition and layer formation. Salts/buffers that may be used include, but are not limited to: tris(hydroxymethyl)aminomethane (tris) buffer, N-tris(hydroxymethyl) methlylglycine (tricine), N,N-bis(2-hydroxyethyl)glycine (bicine), and 3-{[tris(hydroxymethyl)methyl]amino}propanesulfonic acid (TAPS). In some embodiments, the buffer or salt concentration in the buffered polyelectrolyte solution and/or buffered rinse solution is between 1 mM and 100 mM.

One or more complementary adsorption species may be selected for their thin film and deposition properties. Complementary species selection parameters related to favorable layer-by-layer deposition and thin film formation may include, but are not limited to, surface charge, aspect ratio, and alternating adsorption layer species. A variety of complementary species may be used including, but not limited to: cationic polyelectrolytes; anionic polyelectrolytes; natural polyelectrolytes; flame-retardant compounds, such as inorganic hydroxides, phosphated molecules, and sulfated molecules; and colloidal particles, such as clay particles, colloidal silica, silicon-based polymers, carbon nanotubes, and graphene. A dispersion medium for the complementary species and its rinse may be selected according to the properties of the complementary species. For example, anionic clay nanoplatelets may be more easily deposited onto a cationic polyelectrolyte layer in an alkaline pH. In some embodiments, the concentration of complementary species in the complementary species mixture is between 0.5 and 2 wt %

A polyelectrolyte layer may be deposited onto the substrate. A buffered polyelectrolyte solution may be applied to the substrate, as in 110. After the buffered polyelectrolyte solution has been applied, a buffered rinse solution is applied to the substrate, as in 120. The buffered rinse solution may be applied immediately after the buffered polyelectrolyte solution without drying; buffer may remain on the substrate for deposition of the complementary species layer. Through both the buffered polyelectrolyte application 110 and the buffered rinse application 120, the buffer properties and conditions applied to the substrate, such as buffer/salt concentration and pH, may be consistent until application of the next sequential layer. After deposition of the polyelectrolyte layer, a complementary species layer may be deposited onto the substrate. A complementary adsorption species mixture may be applied to the substrate, as in 130. After the complementary species mixture has been applied, a complementary rinse solution may be applied to the substrate, as in 140. The properties and conditions of the complementary species mixture and complementary rinse mixture may be consistent until application of another layer. This bilayer deposition process may continue until the desired number of bilayers has been deposited, as in 150, at which point the substrate may be dried and rinsed, as in 160. Thin film thickness may be controlled by parameters including, but not limited to, number of bilayers, ionic strength, and buffer concentration. In some embodiments, the thickness of the thin film is between 300 nm and 5 μm. In other embodiments, the thin film has between 1 and 10 bilayers. In other embodiments, mass/area is between 0.2 mg/cm² and 1.2 mg/cm². In other embodiments, the thin film has an oxygen transmission rate between 0.0001 and 0.1 cm³/100 in²*day. In other embodiments, the thin film is composed of greater than 80 wt % complementary species.

This process may be adapted to current layer-by-layer deposition processes and used with a variety of substrates in a variety of conditions. In some processes, a rinse mixture may contain the same buffered solute as the polyelectrolyte solution, and adaptation may involve substituting this buffered solute for the rinse solution. A variety of layer-by-layer deposition techniques may be used, such as spray coating, spin coating, and immersion/dip coating. A variety of substrates may be used, such as PET films, silicon wafers, ABS sheets, and polymers.

According to a particular embodiment of the disclosure, nano-objects may complement polyelectrolytes to create nanocomposite thin films with certain structural, optical, or electrical properties. These properties include reduced gas permeation, anti-reflection, conductivity, and catalysis. Nano-objects may include, but are not limited to: clay, such as sodium montmorillonite, hectorite, saponite, bentonite, halloysite, and vermiculite; carbon nanotubes; and graphene.

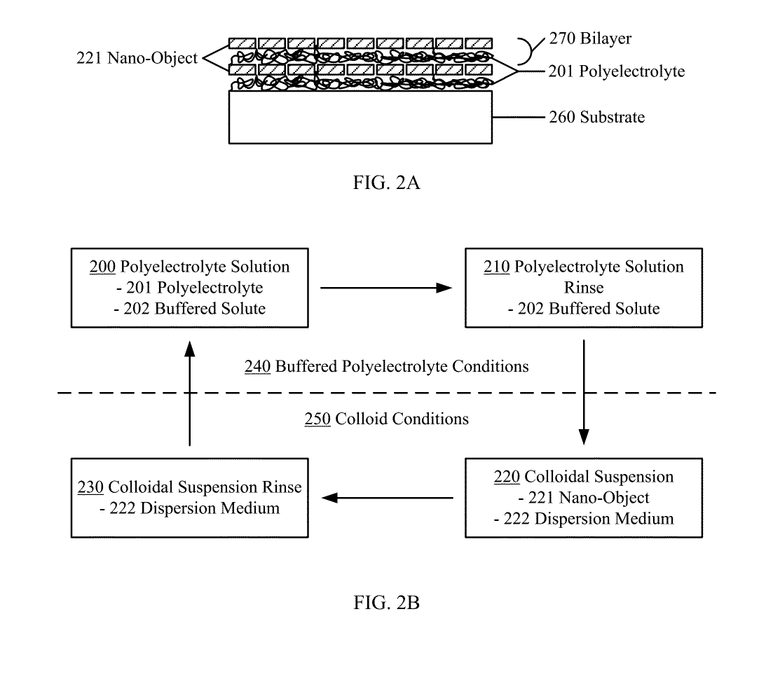

FIG. 2A is an exemplary diagram of a substrate coated in two bilayers of a nano-object and a polyelectrolyte, according to embodiments of the disclosure. FIG. 2B is an exemplary flow diagram of a process for creating a coated substrate such as that of FIG. 2A, according to embodiments of the disclosure.

In FIG. 2A a layer of polyelectrolytes 201 and a layer of nano-objects 221 form a bilayer 270. In this example, two bilayers are coating a substrate 260. This configuration of alternating nano-objects 221 and polyelectrolytes 201 may be used to form an oxygen barrier. The brick structure of the nano-objects 221 creates a tortuous path for diffusing gases, lowering the permeability of the film. Other films may be formed by changing the components, such as a conducting film formed by carbon nanotubes or a flame-retardant film formed by phosphates.

In FIG. 2B, a polyelectrolyte solution 200 contains the polyelectrolyte 201 in a buffered solute 202. The buffered solute 202 may be calibrated to improve growth of the thin film. A polyelectrolyte solution rinse 210 contains the buffered solute 202 that was used in the polyelectrolyte solution 200. This common buffered solute 202 may be kept at the same buffer/salt concentration and pH in both the polyelectrolyte solution 200 and the rinse 202. A colloidal suspension 220 contains nano-objects 221 in a dispersion medium 222. A suspension rinse 230 contains the dispersion medium 222 that was used in the colloidal suspension 220. The dispersion medium 222 may be calibrated to improve certain characteristics of the nano-object layer, and may be kept at the same pH in both the colloidal suspension 220 and the colloidal suspension rinse 230.

The substrate 260 is exposed to the polyelectrolyte solution 200 and rinsed with the polyelectrolyte solution rinse 210 for deposition of polyelectrolytes 201. The substrate 260 is then exposed to the colloidal suspension 220 and rinsed with the colloidal suspension rinse 230 for deposition of nano-objects 221, forming a bilayer 270 of polyelectrolytes 201 and nano-objects 221. This process may be repeated to form the desired number of bilayers 270. By using the buffered solute 202 at the same buffered conditions 240 in the polyelectrolyte solution 200 and polyelectrolyte solution rinse 210 and the dispersion medium 222 at the same colloid conditions 250 in the colloidal suspension 220 and colloidal suspension rinse 230, the substrate 260 may be exposed to the same conditions throughout each layer deposition and rinse stage.

### EXPERIMENTAL PROTOCOLS

### Ex. 1

### 0.1 wt % PAH/50 mM Tris Buffer (pH 7.5); 1 wt % MMT (pH 10)

Polyallylamine hydrochloride (PAH) was added to a 50 mM solution of tris(hydroxymethyl)aminomethane (Tris) to form a cationic solution containing 0.1 wt % PAH. The cationic solution was adjusted to pH 7.5 with 1 M NaOH and 5 M HCl. Montmorillonite clay (MMT) was suspended in deionized (DI) water to form an anionic suspension containing 1 wt % MMT. The anionic suspension was adjusted to pH 10 with 1 M NaOH.

A silicon wafer was dipped into the cationic solution for one minute, and subsequently dipped into a Tris solution at pH 7.5. The silicon wafer was then dipped into the anionic suspension for one minute and subsequently dipped into a NaOH solution at pH 10. This dipping process was repeated until films of 2, 4, 6, and 8 bilayers were produced, after which each film was washed with DI water and dried at 70° C. for 24 hr.

The oxygen transmission rates were measured for the thin films and are provided in the following table:

| PAH/MMT | Oxygen Transmission Rate |
|---|---|
| Bilayers | (cc/100 in² · day) |
| 2 | 0.0733 |
| 4 | 0.011 |
| 6 | 0.0004 |
| 8 | 0.0003 |

### Ex. 2

### 0.1 wt % PAH/50 mM Tris Buffer (pH 7.5); 1 wt % VMT (pH 10)

PAH was added to a 50 mM solution of Tris to form a cationic solution containing 0.1 wt % PAH. The cationic solution was adjusted to pH 7.5 with 1 M NaOH and 5 M HCl. Vermiculite clay (VMT) was suspended in DI water to form an anionic suspension containing 1 wt % VMT. The anionic suspension was adjusted to pH 10 with 1 M NaOH.

A silicon wafer was dipped into the cationic solution for one minute, and subsequently dipped into a Tris solution at pH 7.5. The silicon wafer was then dipped into the anionic suspension for one minute and subsequently dipped into a NaOH solution at pH 10. This dipping process was repeated until films of 2, 4, 6, and 8 bilayers were produced, after which each film was washed with DI water and dried at 70° C. for 24 hr.

The oxygen transmission rates were measured for the thin films and are provided in the following table:

| PAH/VMT Bilayers | Oxygen Transmission Rate (cc/100 in² · day) |
|---|---|
| 2 | 0.1 |
| 4 | 0.0351 |
| 6 | 0.0028 |
| 8 | 0.0005 |

### Ex. 3

### 0.1 wt % CH/50 mM Tris Buffer (pH 6); 1 wt % MMT (pH 10)

Chitosan (CH) was added to a 50 mM solution of Tris to form a cationic solution containing 0.1 wt % CH. The cationic solution was adjusted to pH 6 with 1 M NaOH and 5 M HCl. MMT was suspended in DI water to form an anionic suspension containing 1 wt % MMT. The anionic suspension was adjusted to pH 10 with 1 M NaOH.

A silicon wafer was dipped into the cationic solution for one minute, and subsequently dipped into a Tris solution at pH 6. The silicon wafer was then dipped into the anionic suspension for one minute and subsequently dipped into a NaOH solution at pH 10. This dipping process was repeated until films of 2, 4, 6, and 8 bilayers were produced, after which each film was washed with DI water and dried at 70° C. for 24 hr.

The oxygen transmission rates were determined for the thin films and are provided in the following table:

| CH/MMT Bilayers | Oxygen Transmission Rate (cc/100 in² · day) |
|---|---|
| 2 | 0.0383 |
| 4 | 0.0063 |
| 6 | 0.0013 |
| 8 | 0.0027 |

### Ex. 4

### 0.1 wt % CH/50 mM Tris Buffer (pH 6); 1 wt % VMT (pH 10)

CH was added to a 50 mM solution of Tris to form a cationic solution containing 0.1 wt % CH. The cationic solution is adjusted to pH 6 with 1 M NaOH and 5 M HCl. VMT was suspended in DI water to form an anionic suspension containing 1 wt % VMT. The anionic suspension was adjusted to pH 10 with 1 M NaOH.

A silicon wafer was dipped into the cationic solution for one minute, and subsequently dipped into a Tris solution at pH 6. The silicon wafer was then dipped into the anionic suspension for one minute and subsequently dipped into a NaOH solution at pH 10. This dipping process was repeated until films of 2, 4, 6, and 8 bilayers were produced, after which each film was washed with DI water and dried at 70° C. for 24 hr.

The oxygen transmission rates, thicknesses, and permeabilities were determined for the thin films and are provided in the following table:

| | Oxygen | | |
|---|---|---|---|
| CH/VMT | Transmission Rate | Thickness | Permeability |
| Bilayers | (cc/m² · day) | (μm) | (10⁻²⁰ cc · cm/cm² · Pa · s) |
| 2 | 1.221 | 0.6 ± 0.2 | 194 |
| 4 | 0.122 | 1.0 ± 0.2 | 28.4 |
| 6 | 0.009 | 1.6 ± 0.2 | 3.40 |
| 8 | 0.005 | 4.3 ± 0.7 | 4.57 |

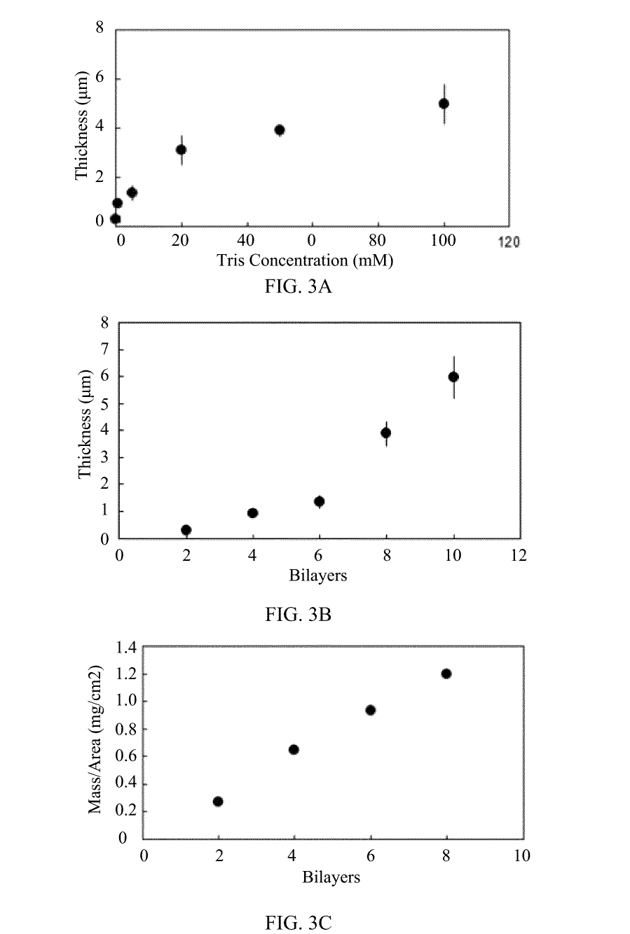

FIG. 3A is a graph of thin film thickness as a function of tris concentration for 8 bilayer CH-tris/VMT assemblies deposited on silicon wafers. As the tris concentration in the CH and rinse solutions increased, the thickness of the thin film increased inverse exponentially. FIG. 3B is a graph of thin film thickness as a function of bilayers deposited with 50 mM tris in the CH solution and rinse on silicon wafers. As the number of bilayers increased, the thin film thickness increased supralinearly. FIG. 3C is a graph of thin film mass deposited as a function of bilayers deposited with 50 mM tris in the CH solution and rinse. As the number of bilayers increased, the mass of the thin film increased roughly linearly.

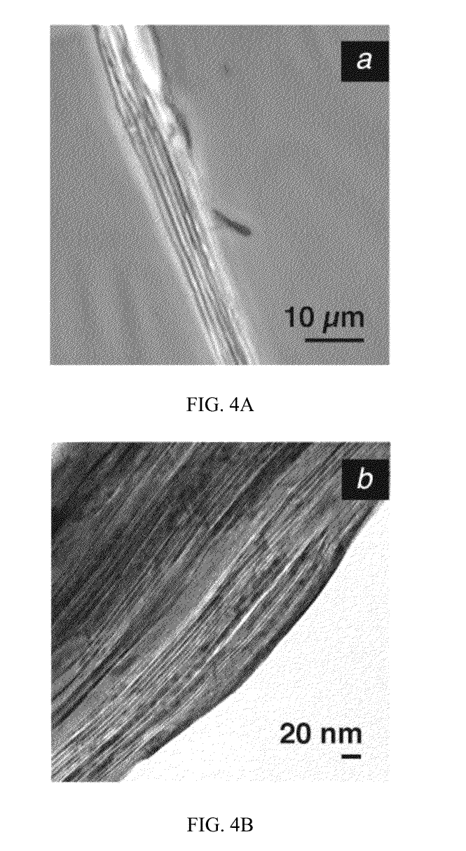

FIG. 4A is an optical micrograph of the cross-section of an 8 bilayer CH-tris/VMT film, deposited on PET and embedded in epoxy taken in phase contrast mode. FIG. 4B is a TEM micrograph of the outermost edge of the cross-section of an 8 bilayer CH-tris/VMT film, deposited on PET and embedded in epoxy. The well-ordered platelets contribute to the high oxygen barrier of the thin films.

Although the present invention has been described in terms of specific embodiments, it is anticipated that alterations and modifications thereof will become apparent to those skilled in the art. Therefore, it is intended that the following claims be interpreted as covering all such alterations and modifications as fall within the true spirit and scope of the invention.

What is claimed is:

1. A layer-by-layer deposition process for a thin film having a polyelectrolyte and a complementary species, comprising:
calibrating a buffered polyelectrolyte solution and a buffered rinse solution;
depositing a polyelectrolyte layer on a substrate, including:
applying the buffered polyelectrolyte solution to the substrate;
applying the buffered rinse solution to the substrate after the buffered polyelectrolyte solution has been applied;
depositing a complementary species layer on the polyelectrolyte layer, including:
applying a complementary species mixture to the substrate; and
applying a complementary species rinse solution to the substrate after the complementary species mixture has been applied.

2. The process of claim 1, further comprising repeating the polyelectrolyte deposition and complementary species deposition alternately.

3. The process of claim 1, wherein:
the polyelectrolyte has a first net charge;
the complementary species has a second net charge opposite to the first net charge; and
the complementary species comprises a complementary polyelectrolyte, a nano-object, or a colloidal particle.

4. The process of claim 1, wherein calibrating the buffered electrolyte solution and the buffered rinse solution further comprises:
selecting a buffer, a buffer concentration, and a buffer pH for the buffered polyelectrolyte solution and the buffered rinse solution;
adding the buffer to a polyelectrolyte solute to form the buffered polyelectrolyte solution at the buffer concentration;
adding the buffer to a rinse solute to form the buffered rinse solution at the buffer concentration;
adjusting a buffered polyelectrolyte solution pH to the buffer pH; and
adjusting a buffered rinse solution pH to the buffer pH.

5. The process of claim 4, wherein the polyelectrolyte comprises poly(allylamine), polymelamine, poly(melamine-co-formaldehyde), polyvinylpyridine, poly(allylamine hydrochloride) (PAH), poly(2-ethyl-2-oxazoline), poly(diallyl dimethyl ammonium chloride) (polyDADMAC), and polyethylenimine (PEI), poly(acrylic acid) salts, poly(vinyl sulfate), poly(methacrylic acid), poly(sodium styrene sulfonate), chitosan, or collagen.

6. The process of claim 4, wherein the buffer comprises tris(hydroxymethyl)aminomethane (tris) buffer, N-tris(hydroxymethyl) methlylglycine (tricine), N,N-bis(2-hydroxyethyl)glycine (bicine), or 3-{[tris(hydroxymethyl)methyl]amino}propanesulfonic acid (TAPS)

7. The process of claim 4, wherein the complementary species comprises sodium montmorillonite, hectorite, saponite, bentonite, halloysite, vermiculite, carbon nanotubes, or graphene.

8. The process of claim 4, wherein:
the polyelectrolyte is a cationic polyelectrolyte;
the polyelectrolyte solution is cationic;
the complementary species is a clay; and
the complementary species mixture is anionic.

9. The process of claim 4, wherein:
the buffer is tris;
the cationic polyelectrolyte is one of poly(allylamine) hydrochloride and chitosan; and
the complementary species is one of montmorillonite clay and vermiculite clay.

10. A layer-by-layer process for creating a thin film, comprising:
providing a buffered polyelectrolyte solution, a buffered rinse solution, a complementary species mixture, and a complementary rinse solution, wherein:
the buffered polyelectrolyte solution includes a polyelectrolyte and a buffer;
the buffered rinse solution includes the buffer;
the complementary species mixture includes a complementary species;
applying the buffered polyelectrolyte solution to a substrate to create a polyelectrolyte layer;
applying the buffered rinse solution to the substrate after the buffered polyelectrolyte solution has been applied;
applying the complementary species mixture to the substrate after the buffered rinse solution has been applied to create a complementary species layer; and
applying the complementary rinse solution to the substrate after the complementary species mixture has been applied.

11. The process of claim 10, further comprising repeating the application of the buffered polyelectrolyte solution, the application of the buffered rinse solution, the application of the complementary species mixture, and the application of the complementary rinse solution.

12. The process of claim 10, wherein:
the polyelectrolyte layer is cationic; and
the complementary species layer is anionic.

13. The process of claim 12, wherein:
the polyelectrolyte is cationic; and
the complementary species is an anionic clay nanoplatelet.

14. The process of claim 10, wherein the polyelectrolyte comprises poly(allylamine), polymelamine, poly(melamine-co-formaldehyde), polyvinylpyridine, poly(allylamine hydrochloride) (PAH), poly(2-ethyl-2-oxazoline), poly(diallyl dimethyl ammonium chloride) (polyDADMAC), and polyethylenimine (PEI), poly(acrylic acid) salts, poly(vinyl sulfate), poly(methacrylic acid), poly(sodium styrene sulfonate), chitosan, or collagen.

15. The process of claim 10, wherein the buffer comprises tris(hydroxymethyl)aminomethane (tris) buffer, N-tris(hydroxymethyl) methlylglycine (tricine), N,N-bis(2-hydroxyethyl)glycine (bicine), or 3-{[tris(hydroxymethyl)methyl]amino}propanesulfonic acid (TAPS)

16. The process of claim 10, wherein the complementary species comprises sodium montmorillonite, hectorite, saponite, bentonite, halloysite, vermiculite, carbon nanotubes, or graphene.

17. The process of claim 10, wherein:
the polyelectrolyte has a first net charge;
the complementary species has a second net charge opposite to the first net charge; and
the complementary species comprises a complementary polyelectrolyte, a nano-object, or a colloidal particle.

18. The process of claim 10, wherein:
the buffer is tris;
the cationic polyelectrolyte comprises poly(allylamine) hydrochloride or chitosan; and
the complementary species comprises montmorillonite clay or vermiculite clay.

19. The process of claim 10, wherein:
the buffered polyelectrolyte solution and the buffered rinse solution are at or near a first pH; and
the complementary species mixture and the complementary rinse solution are at or near a second pH.

20. The process of claim 19, wherein the buffer is at or near a first concentration in the buffered polyelectrolyte solution and the buffered rinse solution.
